(19) United States
(12) Patent Application Publication
(10) Pub. No.: US 2025/0258047 A1
(43) Pub. Date: Aug. 14, 2025

(54) LOAD SENSOR AND LOAD DETECTING DEVICE

(71) Applicant: Panasonic Intellectual Property Management Co., Ltd., Osaka (JP)

(72) Inventors: Mitsutaka YAMAGUCHI, Gifu (JP); Hiroyuki FURUYA, Osaka (JP); Takafumi HAMANO, Fukuoka (JP)

(21) Appl. No.: 19/188,826

(22) Filed: Apr. 24, 2025

Related U.S. Application Data
(63) Continuation of application No. PCT/JP2023/024095, filed on Jun. 28, 2023.

(30) Foreign Application Priority Data
Nov. 24, 2022 (JP) 2022-187738

(51) Int. Cl. G01L 1/14

(52) U.S. Cl. CPC G01L 1/146

(57) ABSTRACT

A load sensor includes: at least one first electrode; at least one second electrode disposed so as to cross the first electrode; a dielectric body present between the first electrode and the second electrode; a resistor array that has a plurality of resistors in series connection and in which both ends of the series connection are respectively connected to a power supply line on the side of a detection circuit and a ground line; and a connection part configured to connect, to the first electrode, one point out of the both ends of the resistor array and a connection position between the resistors adjacent to each other of the resistor array. Here, the point is set to a position corresponding to identification information of the load sensor.

### CROSS REFERENCE TO RELATED APPLICATION

This application is a continuation of International Application No. PCT/JP2023/024095 filed on Jun. 28, 2023, entitled “LOAD SENSOR AND LOAD DETECTING DEVICE”, which claims priority under 35 U.S.C. Section 119 of Japanese Patent Application No. 2022-187738 filed on Nov. 24, 2022, entitled “LOAD SENSOR AND LOAD DETECTING DEVICE”. The disclosures of the above applications are incorporated herein by reference.

### BACKGROUND OF THE INVENTION

### Field of the Invention

The present invention relates to a load sensor and a load detecting device that detect a load, based on capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

Japanese Laid-Open Patent Publication No. 2021-113787 describes a load detecting device including: a load sensor in which a plurality of sensor parts are disposed so as to be arranged in a matrix shape in a measurement region; and a controller that controls the load sensor to measure a load. Based on change in voltage when a voltage has been applied to a sensor part serving as a measurement target, the controller detects capacitance in the sensor part and measures the load applied to the sensor part, from the detected capacitance.

Since a large number of load sensors having the above configuration are disposed, the load detection range can be significantly widened. However, in such a use form, if wrong arrangement or misconnection has occurred in any of the load sensors, or an operation error has occurred, it is extremely difficult to identify which load sensor is the target.

### SUMMARY OF THE INVENTION

A first aspect of the present invention relates to a load sensor. A load sensor according to this aspect includes: at least one first electrode; at least one second electrode disposed so as to cross the first electrode; a dielectric body present between the first electrode and the second electrode; a resistor array that has a plurality of resistors in series connection and in which both ends of the series connection are respectively connected to a power supply line on a side of a detection circuit and a ground line; and a connection part configured to connect, to the first electrode, one point out of the both ends of the resistor array and a connection position between the resistors adjacent to each other of the resistor array. Here, the point is set to a position corresponding to identification information of the load sensor.

In the load sensor according to the present aspect, when the power supply voltage has been applied to the resistor array via the power supply line, a voltage according to the position of the point, i.e., the identification information, appears in the first electrode. Therefore, by detecting, on the detection circuit side, the voltage that appears in the first electrode when the power supply voltage has been applied to the resistor array, the identification information of the load sensor can be acquired. Therefore, identification of the load sensor can be performed in a simple manner.

A second aspect of the present invention relates to a load detecting device. The load detecting device according to this aspect includes the load sensor according to the first aspect and the detection circuit.

Since the load detecting device according to the second aspect includes the load sensor according to the first aspect, effects similar to those in the first aspect can be exhibited.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1A is a perspective view schematically showing a base member and electrically-conductive elastic bodies set on the upper face of the base member according to Embodiment 1;

FIG. 1B is a perspective view schematically showing a state where conductor wires are set on the structure in FIG. 1A according to Embodiment 1;

FIG. 2A is a perspective view schematically showing a state where threads are set on the structure in FIG. 1B according to Embodiment 1;

FIG. 2B is a perspective view schematically showing a state where a base member is set on the structure in FIG. 2A according to Embodiment 1;

FIG. 3A and FIG. 3B each schematically show a cross section of a load sensor according to Embodiment 1;

FIG. 4A is a plan view schematically showing a configuration of the inside of the load sensor according to Embodiment 1;

FIG. 4B is a plan view of the load sensor according to Embodiment 1;

FIG. 5 is a circuit diagram showing configurations of a detection circuit and the load sensor according to Embodiment 1;

FIG. 6A schematically shows a configuration of a resistor array according to Embodiment 1;

FIG. 6B schematically shows an example of a connection form of each wiring cable with respect to a resistor array according to Embodiment 1;

FIG. 7A to FIG. 7C each show an example of a method of assigning a numeral to a resistor array according to the connection form of a switch element with respect to five connection terminals of the resistor array according to Embodiment 1;

FIG. 8 shows a state of the detection circuit in an identification information reading mode according to Embodiment 1;

FIG. 9 shows a state of the detection circuit in a capacitance measurement mode according to Embodiment 1;

FIG. 10 is a block diagram showing a configuration of a load detecting device according to Embodiment 1;

FIG. 11 shows a configuration of management information retained in an operation terminal according to Embodiment 1;

FIG. 12 is a flowchart showing control performed during identification information reading according to Embodiment 1;

FIG. 13 is a flowchart showing a process performed when an error has occurred, according to Embodiment 1;

FIG. 14 is a circuit diagram showing configurations of the detection circuit and the load sensor according to Embodiment 2;

FIG. 15 shows a state of the detection circuit in the identification information reading mode according to Embodiment 2; and

FIG. 16 shows a state of the detection circuit in the capacitance measurement mode according to Embodiment 2.

It is noted that the drawings are solely for description and do not limit the scope of the present invention in any way.

### DETAILED DESCRIPTION

A load detecting device according to the present invention is applicable to a management system or the like that performs processing in accordance with an applied load. Examples of the management system include a stock management system, a driver monitoring system, a coaching management system, a security management system, and a caregiving/nursing management system.

In the stock management system, for example, by a load sensor provided to a stock shelf, the load of a placed commodity is detected, and the kinds of commodities and the number of commodities present on the stock shelf are detected. Accordingly, in a store, a factory, a warehouse, and the like, the commodities can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

The load detecting device of the embodiments below is applied to a management system as described above, for example. The load detecting device of the embodiments below includes: a load sensor for detecting a load; a detection circuit combined with the load sensor; and a control circuit that controls the detection circuit. The load sensor of the embodiments below is a capacitance-type load sensor. Such a load sensor may be referred to as a “capacitance-type pressure-sensitive sensor element”, a “capacitive pressure detection sensor element”, “a pressure-sensitive switch element”, or the like. The embodiments below are examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 10.

### Embodiment 1

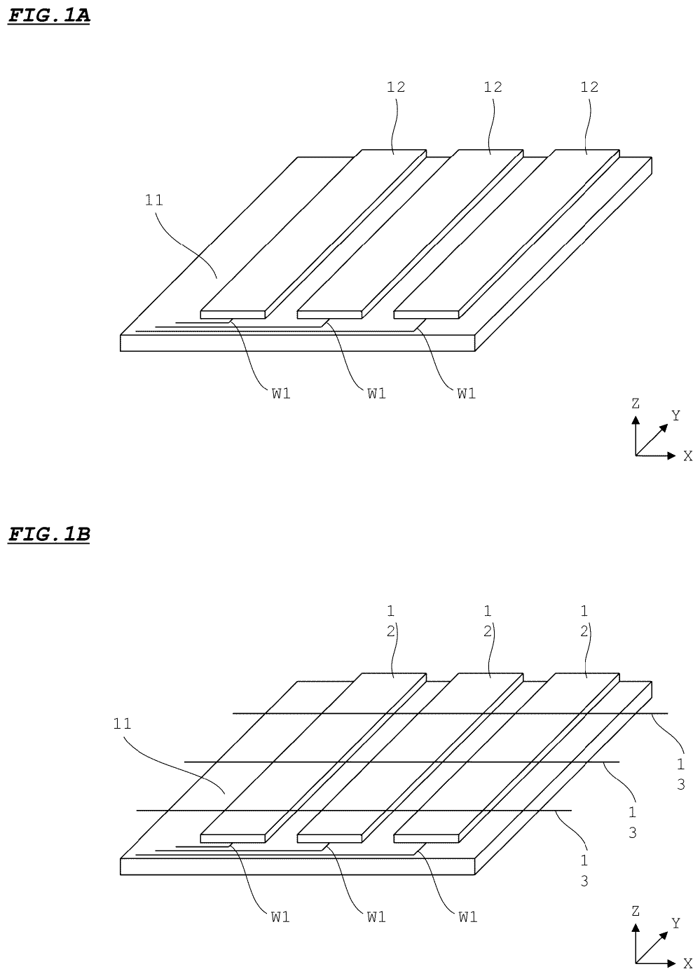

With reference to FIG. 1A to FIG. 4B, the load sensor 10 will be described.

FIG. 1A is a perspective view schematically showing a base member 11 and electrically-conductive elastic bodies 12 set on the upper face (the face on the Z-axis positive side) of the base member 11.

The base member 11 is an insulative flat-plate-shaped member having elasticity. The base member 11 has a rectangular shape in a plan view. The thickness of the base member 11 is constant. The thickness of the base member 11 is 0.01 mm to 2 mm, for example. When the thickness of the base member 11 is small, the base member 11 may be referred to as a sheet member or a film member. The base member 11 is formed from a non-electrically-conductive resin material or a non-electrically-conductive rubber material.

The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are disposed on the upper face (the face on the Z-axis positive side) of the base member 11. In FIG. 1A, three electrically-conductive elastic bodies 12 are disposed on the upper face of the base member 11. The electrically-conductive elastic bodies 12 are each an electrically-conductive member having elasticity. Each electrically-conductive elastic body 12 has a band-like shape that is long in the Y-axis direction. The three electrically-conductive elastic bodies 12 are disposed so as to be arranged with a predetermined interval therebetween in the X-axis direction. At an end portion on the Y-axis negative side of each electrically-conductive elastic body 12, a wiring cable W1 electrically connected to the electrically-conductive elastic body 12 is set. Each wiring cable W1 extends in the Y-axis negative direction, then is bent in the X-axis negative direction, and extends to the vicinity of an end portion on the X-axis negative side of the base member 11.

Each electrically-conductive elastic body 12 is formed on the upper face of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the upper face of the base member 11.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example.

Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT: PSS (i.e., a complex composed of poly (3,4-ethylenedioxythiophene) (PEDOT) and polystyrene sulfonate (PSS)); and electrically-conductive fibers such as a metal-coated organic matter fiber and a metal wire (fiber state), for example.

FIG. 1B is a perspective view schematically showing a state where conductor wires 13 are set on the structure in FIG. 1A.

Each conductor wire 13 has a linear shape, and is disposed so as to be superposed on the upper faces of the electrically-conductive elastic bodies 12 shown in FIG. 1A. In the present embodiment, three conductor wires 13 are disposed so as to be superposed on the upper faces of the three electrically-conductive elastic bodies 12. The three conductor wires 13 are disposed so as to be arranged with a predetermined interval therebetween along the longitudinal direction (the Y-axis direction) of the electrically-conductive elastic bodies 12 so as to cross the electrically-conductive elastic bodies 12. Each conductor wire 13 is disposed, extending in the X-axis direction, so as to extend across the three electrically-conductive elastic bodies 12.

The conductor wire 13 is a covered copper wire, for

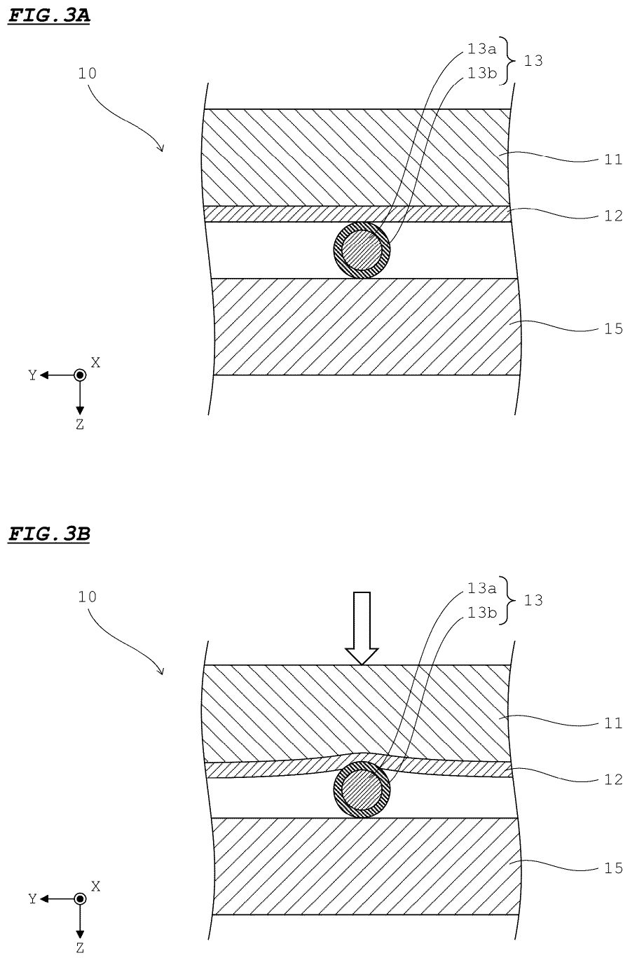

example. The conductor wire 13 is composed of an electrically-conductive member having a linear shape and a dielectric body formed on the surface of the electrically-conductive member. The configuration of the conductor wire 13 will be described later with reference to FIGS. 3A, 3B.

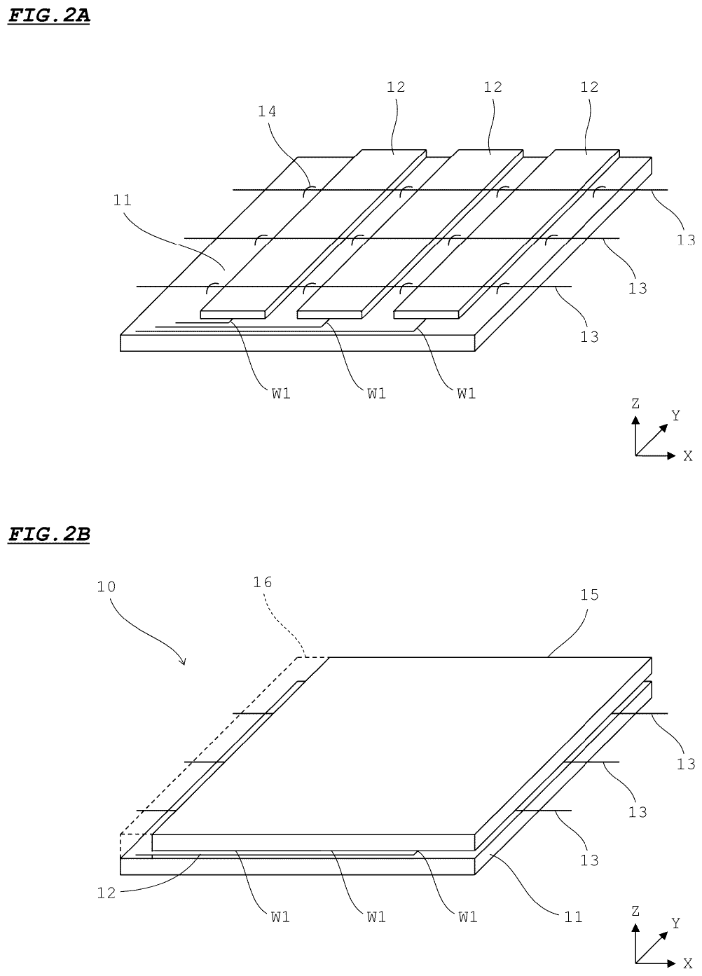

FIG. 2A is a perspective view schematically showing a state where threads 14 are set on the structure in FIG. 1B.

After the conductor wires 13 are disposed as shown in FIG. 1B, each conductor wire 13 is connected to the base member 11 by threads 14 so as to be able to move in the longitudinal direction (the X-axis direction) of the conductor wire 13. In the example shown in FIG. 2A, twelve threads 14 connect the conductor wires 13 to the base member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like.

FIG. 2B is a perspective view schematically showing a state where a base member 15 is set on the structure in FIG. 2A.

The base member 15 is set from above (the Z-axis positive side) the structure shown in FIG. 2A. The base member 15 is an insulative member. The material of the base member 15 is a resin material of at least one type selected from the group consisting of polyethylene terephthalate, polycarbonate, polyimide, and the like, for example. The base member 15 may be formed from the same material as that of the base member 11.

The base member 15 has a flat-plate shape parallel to an X-Y plane. In a plan view, the base member 15 has a rectangular shape, and the width (the X-axis direction) thereof is smaller than that of the base member 11. The width of the base member 15 in the Y-axis direction is the same as that of the base member 11. The thickness in the Z-axis direction of the base member 15 is 0.01 mm to 2 mm, for example.

The outer peripheral four sides of the base member 15 are connected to the outer peripheral four sides of the base member 11 with a silicone rubber-based adhesive, a thread, or the like. Accordingly, the base member 15 is fixed to the base member 11. Further, a circuit board 16 is set, from above, to an end portion on the X-axis negative side of the base member 11, and the conductor wires 13 protruding in the X-axis positive and negative directions are cut. In this manner, the load sensor 10 is completed. The load sensor 10 is used in a state of having been flipped upside down from the state in FIG. 2B.

FIG. 3A and FIG. 3B schematically show a cross section of the load sensor 10 along a plane parallel to a Y-Z plane at the center position in the X-axis direction of the electrically-conductive elastic body 12 of the load sensor 10. FIG. 3A shows a state where no load is applied, and FIG. 3B shows a state where a load is applied.

As shown in FIGS. 3A, 3B, the conductor wire 13 is composed of an electrically-conductive member 13a and a dielectric body 13b formed on the electrically-conductive member 13a. The electrically-conductive member 13a is a member that is electrically-conductive and that has a linear shape. The dielectric body 13b covers the surface of the electrically-conductive member 13a. The electrically-conductive member 13a is formed from copper, for example. The diameter of the electrically-conductive member 13a is about 60 μm, for example.

The dielectric body 13b has an electric insulation property, and is formed from a resin material, a ceramic material, a metal oxide material, or the like, for example. The material of the dielectric body 13b may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the material of the dielectric body 13b may be a metal oxide material of at least one type selected from the group consisting of Al₂O₃, Ta₂O₅, and the like.

As shown in FIG. 3A, when no load is applied, the force applied between the electrically-conductive elastic body 12 and the conductor wire 13, and the force applied between the base member 15 and the conductor wire 13 are approximately zero. From this state, as shown in FIG. 3B, when a load is applied to the face on the Z-axis negative side of the base member 11, the electrically-conductive elastic body 12 and the base member 11 are deformed by the conductor wire 13.

As shown in FIG. 3B, due to the application of a load, the conductor wire 13 is brought close to the electrically-conductive elastic body 12 so as to be wrapped by the electrically-conductive elastic body 12. In association with this, the contact area between the conductor wire 13 and the electrically-conductive elastic body 12 increases. Accordingly, the capacitance between the electrically-conductive member 13a and the electrically-conductive elastic body 12 changes. The capacitance between the electrically-conductive member 13a and the electrically-conductive elastic body 12 is detected, whereby the load applied to this region is acquired.

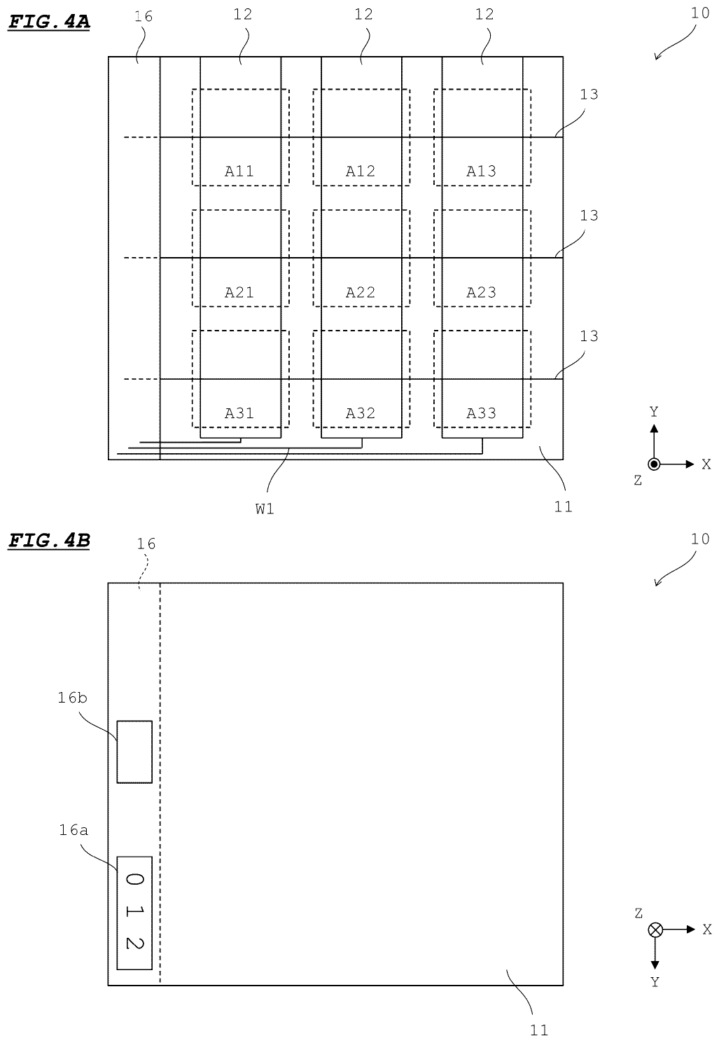

FIG. 4A is a plan view schematically showing a

configuration of the inside of the load sensor 10. In FIG. 4A, the threads 14 and the base member 15 are not shown for convenience.

As shown in FIG. 4A, element parts A11, A12, A13, A21, A22, A23, A31, A32, A33 in which capacitance changes in accordance with a load are formed at positions where the three electrically-conductive elastic bodies 12 and the three conductor wires 13 cross each other. Each element part includes an electrically-conductive elastic body 12 and a conductor wire 13 in the vicinity of the intersection between the electrically-conductive elastic body 12 and the conductor wire 13.

In each element part, the conductor wire 13 forms one pole (e.g., positive pole) for capacitance, and the electrically-conductive elastic body 12 forms the other pole (e.g., negative pole) for capacitance. That is, the electrically-conductive member 13a (see FIGS. 3A, 3B) in the conductor wire 13 forms one electrode of the load sensor 10 (capacitance-type load sensor), the electrically-conductive elastic body 12 forms the other electrode of the load sensor 10 (capacitance-type load sensor), and the dielectric body 13b (see FIGS. 3A, 3B) included in the conductor wire 13 corresponds to the dielectric body that defines the capacitance in the load sensor 10 (capacitance-type load sensor).

When a load is applied in the Z-axis direction to each element part, the conductor wire 13 is wrapped by the electrically-conductive elastic body 12. Accordingly, the contact area between the conductor wire 13 and the electrically-conductive elastic body 12 changes, and the capacitance between the conductor wire 13 and the electrically-conductive elastic body 12 changes. An end portion of each conductor wire 13 and an end portion of the wiring cable W1 set to each electrically-conductive elastic body 12 are connected to a detection circuit 20 described later via the circuit board 16.

When a load is applied to the element part A11, the contact area between the electrically-conductive member 13a of the conductor wire 13 and the electrically-conductive elastic body 12 increases via the dielectric body 13b in the element part A11. In this case, when the capacitance between the electrically-conductive elastic body 12 on the most X-axis negative side and the conductor wire 13 on the most Y-axis positive side is detected, the load applied to the element part A11 can be calculated. Similarly, in another element part as well, when the capacitance between the electrically-conductive elastic body 12 and the conductor wire 13 crossing each other in the other element part is detected, the load applied to the other element part can be calculated.

A wiring pattern is formed on the face on the Z-axis negative side of the circuit board 16. In corresponding terminal regions on this wiring pattern, the three conductor wires 13 (the electrically-conductive members 13a) and the three wiring cables W1 are respectively soldered. On the circuit board 16, a connector (not shown) is disposed, and the wiring pattern is connected to this connector. Accordingly, the three conductor wires 13 (the electrically-conductive members 13a) and the three wiring cables W1 are connected to corresponding terminals of the connector via the wiring pattern on the circuit board 16. The connector is connected to the later-described detection circuit 20 via a cable. In this manner, the three conductor wires 13 (the electrically-conductive members 13a) and the three wiring cables W1 are connected to the detection circuit 20.

Further, resistor arrays 111 and switch elements 112 described later are mounted to the circuit board 16. A wiring pattern for connecting these resistor arrays 111 and switch elements 112 to corresponding terminals of the connector is further disposed on the circuit board 16. Accordingly, the resistor arrays 111 and the switch elements 112 are connected to the detection circuit 20.

FIG. 4B is a plan view showing a configuration of the load sensor 10.

In FIG. 4B, a state where the load sensor 10 has been flipped upside down is shown. That is, the upper face of the base member 11 being the load detection face is shown in FIG. 4B.

As shown in FIG. 4B, a label 16a and a storage medium 16b are attached to the region, in the upper face of the base member 11, that corresponds to the circuit board 16. Identification information of the load sensor 10 is printed on the label 16a, and identification information of the load sensor 10 is readably retained in the storage medium 16b. The storage medium 16b is a bar code or a QR code (registered trademark), for example. The storage medium 16b may be another readable medium such as an RFID tag.

The identification information is the manufacturing serial number of the load sensor 10, for example. In this case, on the label 16a, a numeral indicating the manufacturing serial number of the load sensor 10 is shown, and this serial number is retained in the storage medium 16b. A user can grasp the identification information of the load sensor 10 from the indication on the label 16a. In addition, the user can manage the identification information of each load sensor 10 by reading the identification information from the storage medium 16b with a portable terminal, a bar code reader, or the like.

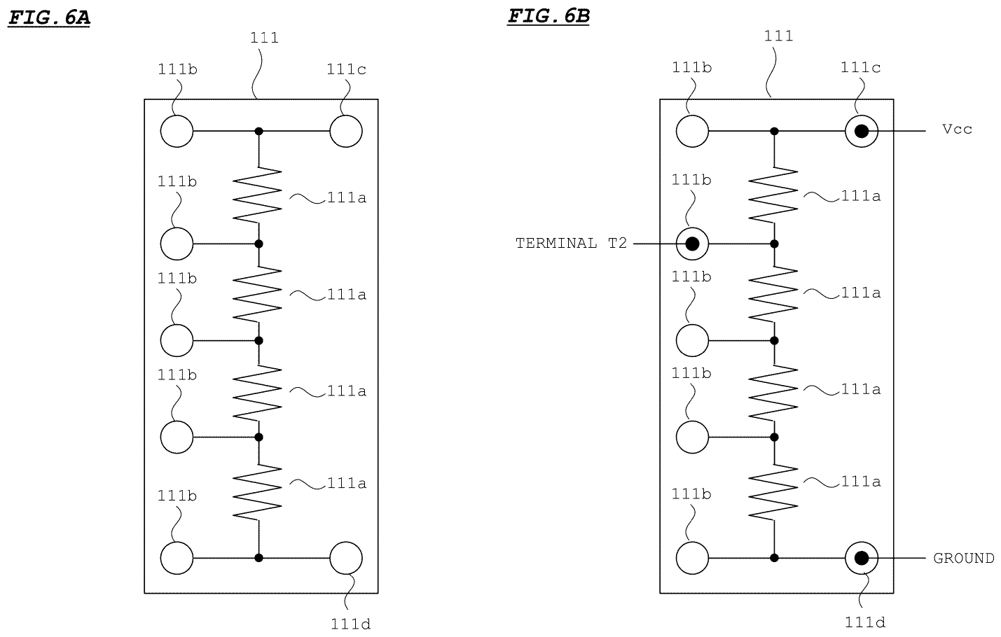

In the present embodiment, as described later, these pieces of identification information are also retained by the resistor array mounted on the circuit board 16. The retaining method of the identification information by the resistor array and the reading method thereof will be described later with reference to FIG. 6A to FIG. 9.

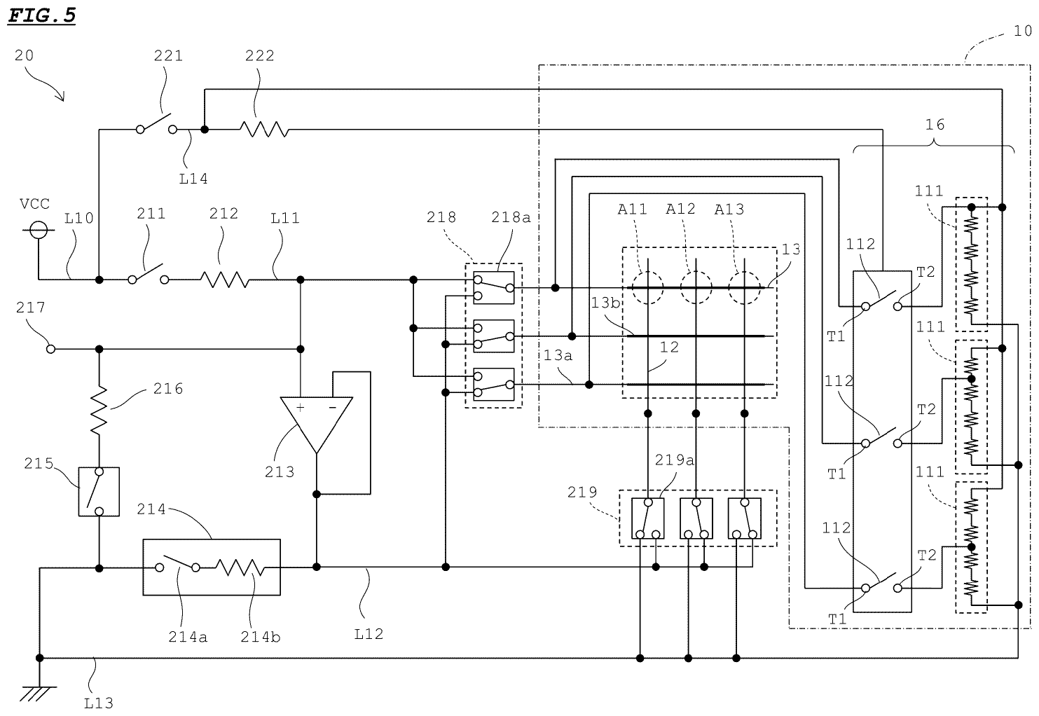

FIG. 5 is a circuit diagram showing configurations of the detection circuit 20 and the load sensor 10. In FIG. 5, for convenience, as the configuration of the load detection region of the load sensor 10, only the conductor wires 13 (the electrically-conductive members 13a, the dielectric bodies 13b) and the electrically-conductive elastic bodies 12 are shown, and each electrically-conductive elastic body 12 is shown in a linear shape.

As a configuration for measuring the capacitance in the load sensor 10, the detection circuit 20 includes a switch 211, a resistor 212, an equipotential generator 213, switches 214, 215, a resistor 216, an output terminal 217, a first switchover part 218, and a second switchover part 219. The detection circuit 20 is a circuit for detecting the capacitance at a crossing position between the conductor wire 13 and the electrically-conductive elastic body 12 with respect to the load sensor 10.

One terminal of the switch 211 is connected to a power supply line L10 being at a power supply voltage Vcc, and the other terminal of the switch 211 is connected to the resistor 212. The resistor 212 is disposed between the switch 211 and a plurality of the conductor wires 13. A supply line L11 is connected to the downstream side terminal of the resistor 212.

The supply line L11 is connected to the first switchover part 218, the equipotential generator 213, the resistor 216, and the output terminal 217. The output-side terminal of the equipotential generator 213 is connected to a supply line L12. The equipotential generator 213 is an operational amplifier, and the output-side terminal and the input-side negative terminal are connected to each other. The equipotential generator 213 generates a suppression voltage having the same potential as the potential (the potential on the downstream side of the resistor 212) in the supply line L11.

The supply line L12 is connected to the equipotential generator 213, the first switchover part 218, and the second switchover part 219. The switch 214 is an electric element including a resistor component interposed between the supply line L12 and a ground line L13. In FIG. 5, for convenience, the switching function of the switch 214 is shown as a switch part 214a, and the resistor component of the switch 214 is shown as a resistor part 214b. When the switch part 214a is set to an ON-state, the supply line L12 is connected to the ground line L13 via the resistor part 214b.

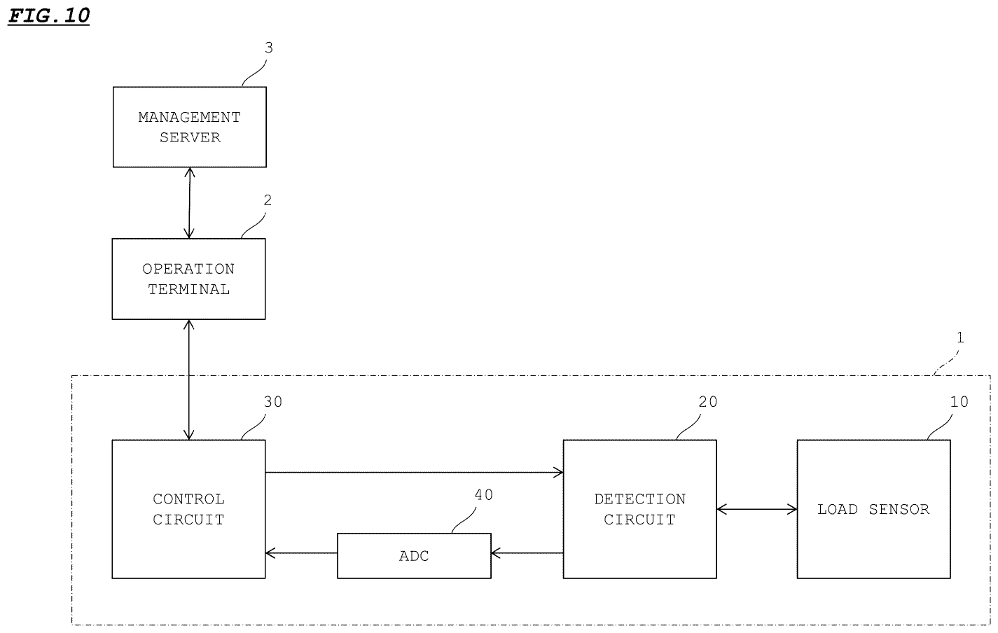

The switch 215 is interposed between the supply line L11 and the ground line L13. When the switch 215 is set to an ON-state, the supply line L11 is connected to the ground line L13 via the resistor 216. The output terminal 217 is connected to an AD converter 40 (see FIG. 10) described later.

The first switchover part 218 selectively connects either one of the supply line L11 for supplying the potential on the downstream side of the resistor 212 and the supply line L12 for supplying the suppression voltage, to the conductor wire 13.

Specifically, the first switchover part 218 includes three multiplexers 218a. The output-side terminals of the three multiplexers 218a are connected, in a one-to-one relationship, to the three conductor wires 13 (the electrically-conductive members 13a), respectively. Each multiplexer 218a is provided with two input-side terminals. The supply line L11 is connected to one input-side terminal, and to this input-side terminal, a voltage is applied from the power supply line L10 via the resistor 212 and the supply line L11. The other input-side terminal of the multiplexer 218a is connected to the supply line L12, and to this input-side terminal, the suppression voltage is applied from the equipotential generator 213 via the supply line L12.

The second switchover part 219 selectively connects either one of the supply line L12 for supplying the suppression voltage and the ground line L13 connected to the ground, to each electrically-conductive elastic body 12.

Specifically, the second switchover part 219 includes three multiplexers 219a. The output-side terminals of the three multiplexers 219a are connected, in a one-to-one relationship, to the three electrically-conductive elastic bodies 12, respectively. Each multiplexer 219a is provided with two input-side terminals. The supply line L12 is connected to one input-side terminal, and to this input-side terminal, the suppression voltage is applied from the equipotential generator 213 via the supply line L12. The other input-side terminal of the multiplexer 219a is connected to the ground line L13.

Switching of the switch 211, the switch part 214a, the switch 215, the multiplexers 218a, a219a, and a switch 221 is controlled by a control circuit 30 as described later.

As a configuration for reading the identification information of the load sensor 10, the detection circuit 20 includes the switch 221 and a resistor 222. A wiring cable L14 between the switch 221 and the resistor 222 is connected to one terminal of each of three resistor arrays 111. The resistor 222 is connected to each of three switch elements 112. When the switch 221 is closed, the power supply voltage Vcc in the power supply line L10 is applied to one terminal of each of the three resistor arrays 111 and the three switch elements 112.

On the circuit board 16 shown in FIG. 2B, the three resistor arrays 111 and the three switch elements 112 are mounted, as shown in FIG. 5. Each resistor array 111 is configured by a plurality of resistors being in series connection. Here, four resistors are in series connection to form a resistor array 111. The resistance values of these four resistors are the same. The three resistor arrays 111 have the same configuration.

The three switch elements 112 are disposed so as to correspond to the three resistor arrays 111 and the three conductor wires 13, respectively. Each switch element 112 is interposed in a wiring cable that connects a corresponding resistor array 111 and a corresponding conductor wire 13 (the electrically-conductive member 13a), and switches the resistor array 111 and the conductor wire 13, between connection and non-connection.

Each switch element 112, when the power supply voltage Vcc is applied thereto via the resistor 222, operates so as to connect a resistor array 111 and a conductor wire 13 to each other. That is, the switch element 112 is switched from a non-conductive state (open state) to a conductive state (closed state) by the power supply voltage Vcc being applied thereto via the resistor 222.

Each switch element 112 is implemented by a switching

transistor, for example. In this case, to the base terminal of the switching transistor forming each switch element 112, the power supply voltage Vcc is applied via the resistor 222. The switch element 112 may be a switch element of another type, such as an electromagnetic switch element, that is switched from a non-conductive state (open state) to a conductive state (closed state) through application of the power supply voltage Vcc.

In each resistor array 111, one terminal is connected to the wiring cable L14 between the resistor 222 and the switch 221 on the detection circuit 20 side, and the other terminal is connected to the ground line L13. These connections are performed via the connector and the wiring pattern on the circuit board 16 and a cable connected to the connector, as described above.

One terminal T1 of each of the three switch elements 112 is connected, via the wiring pattern on the circuit board 16, to a corresponding one of terminal regions on the circuit board 16 to which the three conductor wires 13 (the electrically-conductive members 13a) are respectively soldered. Therefore, when the conductor wires 13 are soldered to these terminal regions, each conductor wire 13 and one terminal T1 of a corresponding switch element 112 are connected to each other.

The other terminal T2 of each switch element 112 is connected to one point out of both ends of a corresponding resistor array 111 and the connection positions between adjacent resistors of the resistor array 111.

FIG. 6A schematically shows a configuration of the resistor array 111.

The resistor array 111 includes four resistors 111a, five connection terminals 111b, a power supply connection terminal 111c, and a ground connection terminal 111d. The five connection terminals 111b are each a terminal that is connected to the terminal T2 of the switch element 112. The five connection terminals 111b are each connected to one point out of both ends of the resistor array 111 and connection positions between adjacent resistors 111a. The power supply connection terminal 111c is a terminal to which the wiring cable connected between the switch 221 and the resistor 222 in FIG. 5 is connected. The ground connection terminal 111d is a terminal to which the wiring cable connected to the ground line L13 is connected.

As shown in FIG. 6B, the power supply connection terminal 111c is connected by solder to the wiring pattern, on the circuit board 16, that is connected to the wiring cable L14 between the switch 221 and the resistor 222 in FIG. 5. The ground connection terminal 111d is connected by solder to the wiring pattern, on the circuit board 16, that is connected to the ground line L13 in FIG. 5. In addition, to one of the five connection terminals 111b, the terminal on the resistor array 111 side of the switch element 112 is connected on the circuit board 16 by wire bonding or the like. The connection method is not limited to wire bonding and may be another method.

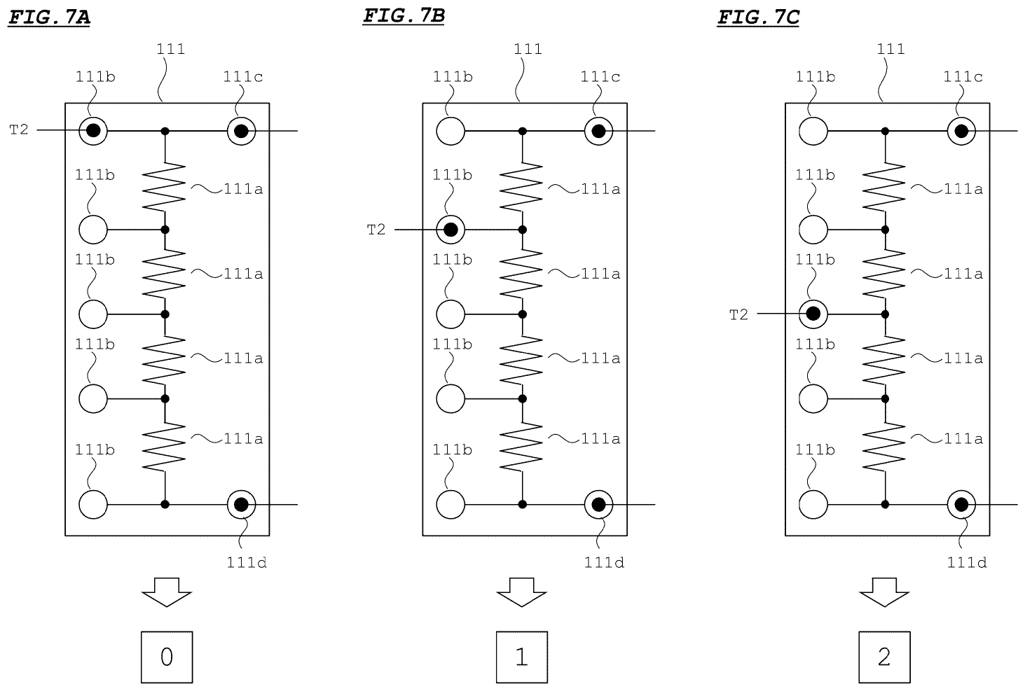

FIGS. 7A to 7C each show an example of a method of assigning a numeral to the resistor array 111 according to the connection form of the terminal T2 of the switch element 112 with respect to the five connection terminals 111b.

Here, among the five connection terminals 111b, when the switch element 112 is connected to the first connection terminal 111b from the top, 0 is assigned, and when the switch element 112 is connected to the second, third, fourth, and fifth connection terminals 111b from the top, 1, 2, 3, and 4 are assigned, respectively. Therefore, five numerals of 0 to 4 are assigned to one resistor array 111.

Here, when the power supply connection terminal 111c and the ground connection terminal 111d are connected to the power supply line L10 and the ground line L13, respectively, a voltage obtained by dividing the power supply voltage Vcc by four resistors appears in the five connection terminals 111b. That is, in this case, in the first connection terminal 111b from the top, a voltage having the same magnitude as that of the power supply voltage Vcc occurs, and in the second, third, fourth, and fifth connection terminals 111b from the top, voltages of (3/4)·Vcc, (2/4)·Vcc, (1/4)·Vcc, and 0 V appear, respectively.

Therefore, in accordance with which of the five connection terminals 111b the terminal T2 of the switch element 112 is connected to, the magnitude of the voltage applied from the resistor array 111 to the conductor wire 13 via the switch element 112 changes between Vcc, (3/4)·Vcc, (2/4)·Vcc, (1/4)·Vcc, and 0 V. Therefore, by detecting this voltage, which of the five connection terminals 111b the switch element 112 is connected to, i.e., the numeral assigned according to the connection form between the resistor array 111 and the terminal T2 of the switch element 112, can be detected.

With reference back to FIG. 5, on the circuit board 16, three sets of the resistor array 111 and the switch element 112 are disposed. As described above, it is possible to express five numerals of 0 to 4 by using one set of the resistor array 111 and the switch element 112. Therefore, by using these three sets of the resistor array 111 and the switch element 112, it is possible to express the number of kinds up to 5 to the third power using 3-digit numbers in base 5. Therefore, by setting the connection position between the resistor array 111 and the terminal T2 of the switch element 112 in each of these sets to a position according to the identification information (e.g., manufacturing serial number) of the load sensor 10, it is possible to cause these three sets of the resistor array 111 and the switch element 112 to retain the identification information of the load sensor 10.

When the number of the resistors 111a included in one resistor array 111 is increased, the kinds of numerals that can be assigned to each digit can be increased. Accordingly, the kinds of identification information that can be expressed by the three resistor arrays 111 can be further increased. In addition, in the configuration in FIG. 5, since three conductor wires 13 are disposed in the load sensor 10, the number of disposed resistor arrays 111 is also three. However, when four or more conductor wires 13 are disposed in the load sensor 10, four or more sets of the resistor array 111 and the switch element 112 can be disposed in the load sensor 10. Accordingly, the number of digits that can be expressed by these sets can be increased, and the kinds of identification information that can be expressed by these sets can be further increased.

The method of assigning the numerals is not limited to the method shown in FIGS. 7A to 7C. For example, in the example in FIGS. 7A to 7C, when the terminal T2 of the switch element 112 is connected to the first connection terminal 111b from the bottom, 0 may be assigned, and when the terminal T2 of the switch element 112 is connected to the second, third, fourth, and fifth connection terminals 111b from the bottom, 1, 2, 3, and 4 may be assigned, respectively.

Next, control of the detection circuit 20 during identification information reading will be described.

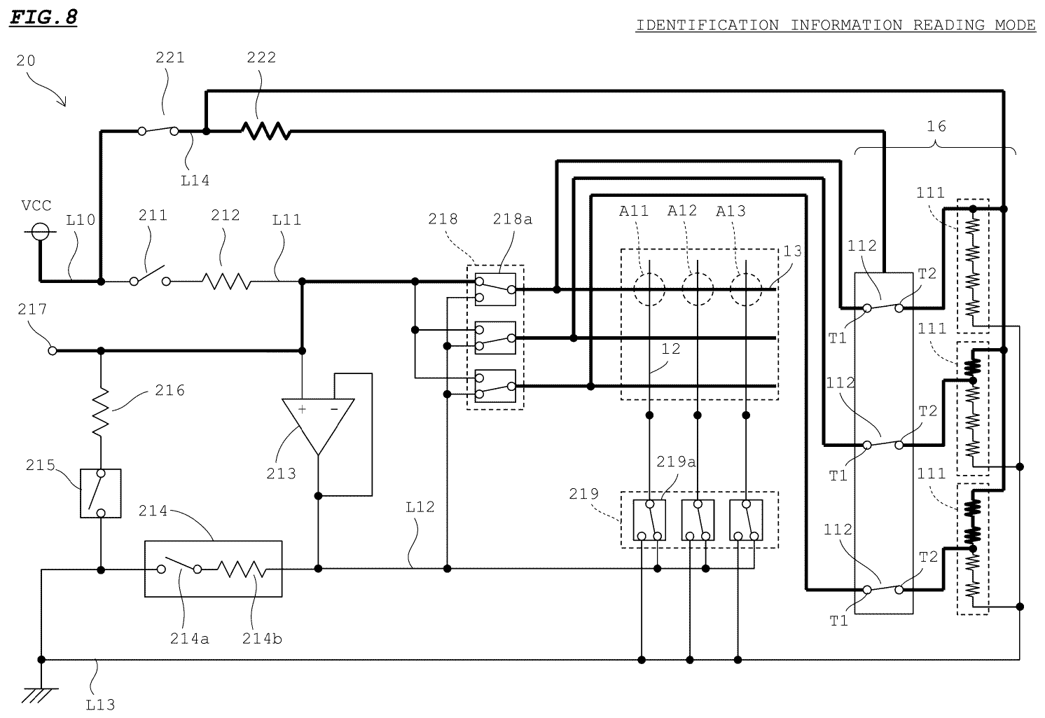

FIG. 8 shows a state of the detection circuit 20 during reading of identification information (identification information reading mode). In FIG. 8, for convenience, wiring cables and resistors related to identification information reading are indicated by thick lines.

During identification information reading, the switches 211, 214, 215 are opened, and the switch 221 is closed. By the switch 221 being closed, the power supply voltage Vcc is supplied to each of the three resistor arrays 111. In addition, the power supply voltage Vcc is applied to each of the three switch elements 112 via the resistor 222. Accordingly, each of the three switch elements 112 is switched to a conductive state.

When the three switch elements 112 have been switched to a conductive state in this manner, a voltage according to the connection form of the terminal T2 of each switch element 112 to a corresponding resistor array 111, i.e., which of the five connection terminals 111b in FIG. 6A the terminal T2 is connected to, is applied via each switch element 112 to a corresponding conductor wire 13.

Here, in the state in FIG. 8, among the three multiplexers 218a of the first switchover part 218, only the multiplexer 218a in the uppermost row is connected to the supply line L11. Therefore, the voltage applied to the conductor wire 13 in the uppermost row via the resistor array 111 in the uppermost row and the switch element 112 in the uppermost row is supplied to the output terminal 217 via the supply line L11.

At this time, to the three electrically-conductive elastic bodies 12 crossing the conductor wire 13 in the uppermost row, the suppression voltage having the same potential as that in the supply line L11 is being applied from the equipotential generator 213, and thus, the element parts A11 to A13 are disabled in terms of circuitry. Therefore, the voltage from the resistor array 111 in the uppermost row is appropriately reflected in the output terminal 217. Therefore, by the later-described control circuit 30 detecting the voltage at the output terminal 217, the numeral assigned according to the connection form between the resistor array 111 in the uppermost row and the switch element 112 in the uppermost row is acquired.

Subsequently, when the multiplexer 218a in the uppermost row of the first switchover part 218 has been switched to the supply line L12 side, the multiplexer 218a in the middle row is switched to the supply line L11 side. Accordingly, the voltage applied to the conductor wire 13 in the middle row via the resistor array 111 in the middle row and the switch element 112 in the middle row is supplied to the output terminal 217 via the supply line L11. Therefore, by the later-described control circuit 30 detecting the voltage at the output terminal 217, the numeral assigned according to the connection form between the resistor array 111 in the middle row and the switch element 112 in the middle row is acquired.

Subsequently, the multiplexer 218a in the middle row of the first switchover part 218 is switched to the supply line L12 side and the multiplexer 218a in the lowermost row is switched to the supply line L11 side. Accordingly, the voltage applied to the conductor wire 13 in the lowermost row via the resistor array 111 in the lowermost row and the switch element 112 in the lowermost row is supplied to the output terminal 217 via the supply line L11. Therefore, by the later-described control circuit detecting the voltage at the output terminal 217, the numeral assigned according to the connection form between the resistor array 111 in the lowermost row and the switch element 112 in the lowermost row is acquired.

From the three numerals acquired in this manner, three-digit identification information associated with the load sensor 10 is acquired. Then, the identification information acquisition operation ends.

Next, control of the detection circuit 20 during load detection will be described.

For example, in the configuration in FIG. 5, when a load in the element part A11 is to be detected, the three multiplexers 218a included in the first switchover part 218 and the three multiplexers 219a included in the second switchover part 219 are set to the state shown in FIG. 5. That is, the multiplexer 218a in the uppermost row connected to the conductor wire 13 (the electrically-conductive member 13a) forming one electrode of the element part A11 is connected to the supply line L11, and the multiplexer 219a in the leftmost row connected to the electrically-conductive elastic body 12 forming the other electrode of the element part A11 is connected to the ground line L13. In addition, the switches 211, 221, 214, 215 are set to an open state as in FIG. 5. The three switch elements 112 are in a non-conductive state.

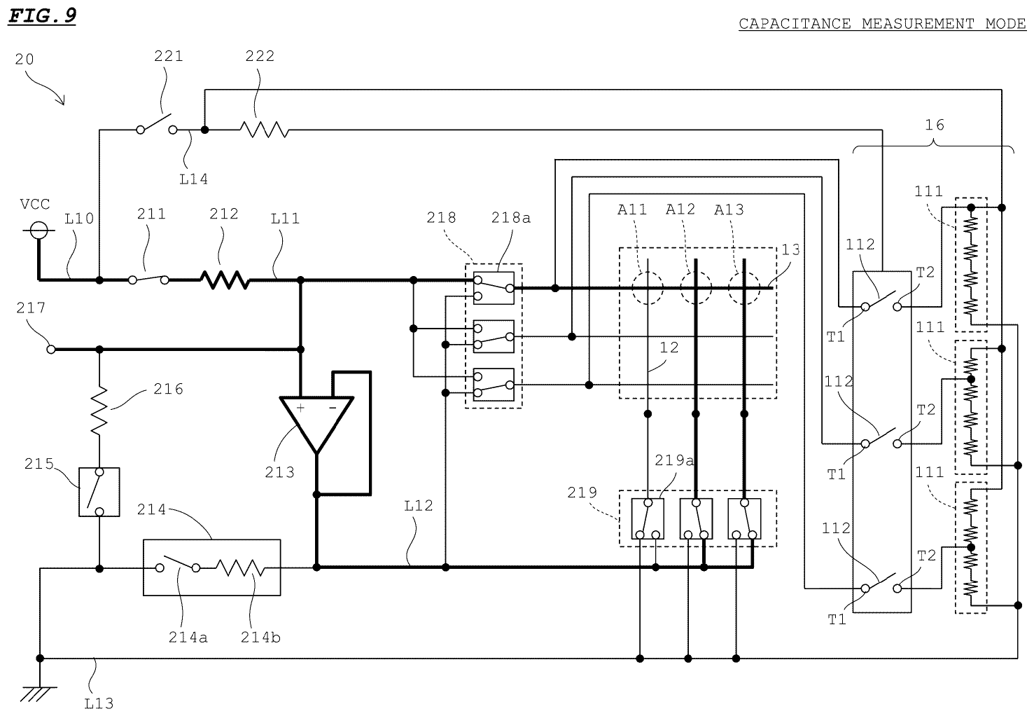

From this state, as shown in FIG. 9, the switch 211 is closed for a certain period. Accordingly, the power supply voltage Vcc is applied to the element part A11, and in accordance with accumulation of electricity in the element part A11, the voltage at the output terminal 217 increases according to the time constant defined by the capacitance in the element part A11 and the resistor 212. As described above, the capacitance in the element part A11 has a value according to the load being applied to the element part A11. Therefore, the voltage value at the output terminal 217 after elapse of a predetermined period after the switch 211 has been closed becomes a value according to the load being applied to the element part A11. From this voltage value, the load according to the capacitance in the element part A11 is calculated.

In the state in FIG. 9, since the switch 221 and the switch elements 112 are open, the three resistor arrays 111 are in a state (float state) of being disconnected from the detection circuit 20. Therefore, the three resistor arrays 111 do not influence the voltage at the output terminal 217. Therefore, from the voltage at the output terminal 217, the capacitance and the load in the element part A11 can be appropriately calculated.

Then, after the switch 211 has been closed for a certain period, the switch 211 is opened, and the switches 214, 215 are closed. Accordingly, electric charge accumulated in the element part A11 is discharged to the ground via the resistor 216 and the switch 215. In addition, if electric charge is accumulated in other element parts, electric charge in these element parts is discharged to the ground via the switch 214.

Then, after discharging has been performed, the switches 214, 215 are opened together with the switch 211. Then, the control is shifted to a step of performing load detection with respect to the element part A12 adjacent on the right of the element part A11. In this step, in order to apply a voltage to this element part A12, among the three multiplexers 219a included in the second switchover part 219, the center multiplexer 219a is connected to the ground line L13 and the remaining two multiplexers 219a are connected to the supply line L12. The state of the three multiplexers 218a included in the first switchover part 218 is kept as is.

In this state, the switch 211 is closed for a certain period, and the power supply voltage Vcc is applied to the element part A12. Then, similar to the above, from the voltage value at the output terminal 217, the load in this element part A12 is calculated. Then, similar to the above, the switches 214, 215 are closed and discharging is performed.

With respect to the other element parts as well, with the first switchover part 218 and the second switchover part 219 controlled, the voltage Vcc is applied to the detection target element part, and from the voltage value at the output terminal 217, the load in the detection target element part is calculated. Then, when load detection has been performed with respect to all the element parts, the same control is performed from the element part A11 and load detection with respect to each element part in the next routine is performed again.

FIG. 10 is a block diagram showing a configuration of a load detecting device 1.

The load detecting device 1 includes the load sensor 10 and the detection circuit 20 described above, the control circuit 30, and the AD converter 40.

The control circuit 30 includes an arithmetic processing circuit such as a CPU (Central Processing Unit) and a memory, and controls each component according to a predetermined program. The control circuit 30 controls the detection circuit 20 as described above to calculate the load in each element part of the load sensor 10. In addition, the control circuit 30 controls the detection circuit 20 as described above to acquire the identification information of the load sensor 10. Further, the control circuit 30 transmits various information including a load detection result, to an operation terminal 2 as appropriate.

The AD converter 40 converts the voltage outputted from the output terminal 217 in FIG. 5 to digital data, and outputs the digital data to the control circuit 30.

The operation terminal 2 is a personal computer, for example. The operation terminal 2 is used for displaying information supplied from the control circuit 30 and for inputting information to the control circuit 30. The operation terminal 2 has installed therein an application program for the load detection using the load detecting device 1. By activating this application program, display of information regarding load detection and input of information are enabled. The operation terminal 2 is not limited to a personal computer and may be a dedicated terminal.

In FIG. 10, one load detecting device 1 is connected to the operation terminal 2, but a plurality of the load detecting devices 1 can be connected to the operation terminal 2. In this case, the operation terminal 2 is used for inputting/outputting information with respect to each connected load detecting device 1. These load detecting devices 1 and the operation terminal 2 form a load detection system.

The operation terminal 2 performs communication with a management server 3 via an external communication network. The management server 3 has stored therein management information of the load sensor 10 in association with the identification information (e.g., manufacturing serial number) of the load sensor 10. The management server 3 is managed and operated by the manufacturer of the load sensor 10, for example. A manager of the manufacturer causes the management server 3 to store characteristic data based on the individual difference of the load sensor 10, in association with the above-described identification information assigned to the load sensor 10, for example. This characteristic data includes data for correcting parameter values used when the capacitance and the load are calculated from the voltage outputted from the output terminal 217 in FIG. 9. This data is set for each element part of the load sensor 10.

When having acquired the identification information of the load sensor 10 through control described with reference to FIG. 8, the control circuit 30 outputs the acquired identification information to the operation terminal 2. In accordance with this, the operation terminal 2 accesses the management server 3 and acquires characteristic data corresponding to the identification information from the management server 3. The acquisition of the characteristic data may be performed by using the identification information read from the storage medium 16b in FIG. 4B.

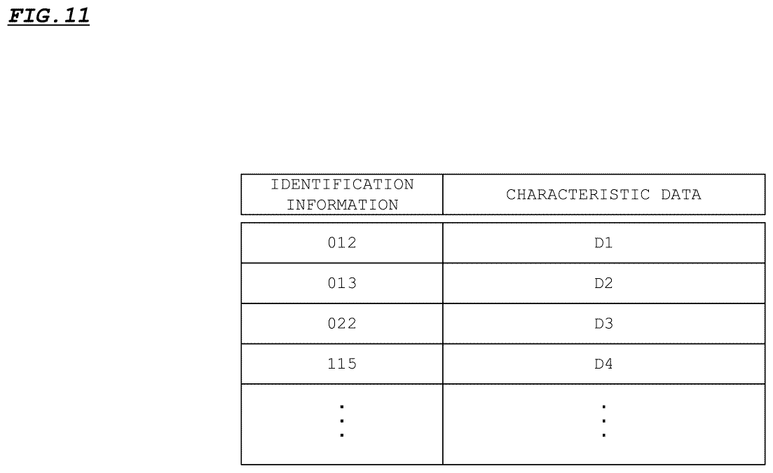

The operation terminal 2 stores, into a storage thereof, the characteristic data acquired from the management server 3, in association with the identification information, as shown in FIG. 11. In the example in FIG. 11, a plurality of the load detecting devices 1 are connected to the operation terminal 2, and characteristic data of the load sensor 10 included in each load detecting device 1 is stored in association with the identification information of the load sensor 10.

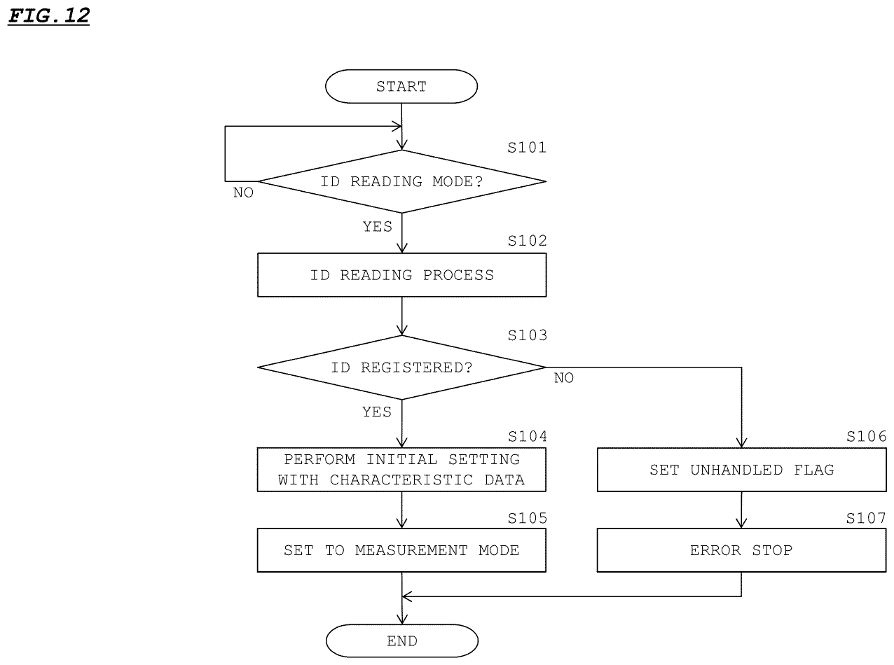

FIG. 12 is a flowchart showing control performed during identification information reading.

When the control mode has been set to the identification information reading mode (S101: YES), the control circuit 30 executes the identification information reading process described with reference to FIG. 8 (S102). Setting of the reading mode is performed upon receiving an identification information reading instruction from the operation terminal 2. For example, in accordance with activation of the load detection system shown in FIG. 10, the operation terminal 2 transmits the identification information reading instruction to each load detecting device 1. Accordingly, the control circuit 30 of each load detecting device 1 sets the control mode to the identification information reading mode.

Next, the control circuit 30 confirms whether or not the read identification information is registered in the operation terminal 2 (S103). Here, the control circuit 30 transmits the read identification information to the operation terminal 2, to confirm the presence or absence of registration of the identification information.

The operation terminal 2 determines whether or not the received identification information is included in the management information in FIG. 11. When the received identification information is included in the management information, the operation terminal 2 transmits, to the control circuit 30, a notification indicating that the registration has been made and characteristic data associated with the identification information.

On the other hand, when the received identification information is not included in the management information, the operation terminal 2 initially accesses the management server 3, and performs a process of acquiring characteristic data corresponding to the identification information, from the management server 3. In response to this, when having received the characteristic data from the management server 3, the operation terminal 2 transmits, together with the received characteristic data, a notification indicating that the registration has been made, to the control circuit 30. At this time, the control circuit 30 stores, into a storage thereof, the received characteristic data, in association with the identification information. On the other hand, when the characteristic data corresponding to the identification information has not been able to be received from the management server 3, a notification indicating that the identification information is not registered is transmitted to the control circuit 30.

When having received, from the operation terminal 2, a notification indicating that the identification information is registered, the control circuit 30 sets the determination in step S103 to YES, performs initial setting on parameter values used when calculating the capacitance and the load in each element part, with characteristic data received together with the notification (S104), and shifts the mode to a measurement mode for load (S105). Then, the control circuit 30 ends the process in FIG. 12.

On the other hand, when having received, from the operation terminal 2, a notification indicating that the identification information is not registered, the control circuit 30 sets the determination in step S103 to NO, sets an unhandled flag indicating that the characteristic data is not registered with respect to the load sensor 10 (S106), and stops the load measurement using the load sensor 10 (S107). In this case, on the operation terminal 2, a notification indicating that there is an error in the load sensor 10 is displayed together with the identification information thereof. Then, the control circuit 30 ends the process in FIG. 12.

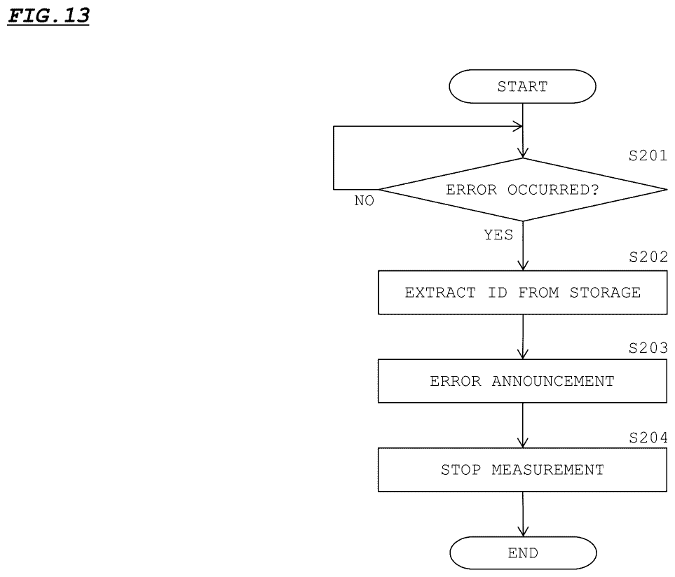

FIG. 13 is a flowchart showing a process performed when an error has occurred.

When an error has occurred in the load sensor 10 (S201), the control circuit 30 extracts, from the storage thereof, the identification information of the load sensor 10 (S202).

Here, in step S201, it is determined that an error has occurred, when the voltage has not been appropriately outputted from the output terminal 217 during measurement of the capacitance with respect to a predetermined element part due to short circuit between the conductor wire 13 and the electrically-conductive elastic body 12 or breakage of the conductor wire or a wiring cable, for example. In step S202, the identification information read in step S102 in FIG. 12 is extracted from the storage. That is, when shifting to the measurement mode in step $105, the control circuit 30 stores, into the storage thereof, the identification information read in step S102. In step S202, this identification information is extracted from the storage.

The control circuit 30 transmits, to the operation terminal 2, a notification indicating that an error has occurred, together with the extracted identification information (S203), and stops the load measurement process (S204). Then, the control circuit 30 ends the process in FIG. 13.

When having received an error notification in step S203, the operation terminal 2 displays, on a display thereof, an error announcement screen including an error message and the identification information received together with this error notification. At this time, the operation terminal 2 may further output, from a speaker thereof, an alert sound or a message voice indicating that an error has occurred.

The user grasps the fact that an error has occurred in any of the load detecting devices 1, with reference to the error announcement screen displayed on the display. At this time, by checking the identification information of the load sensor 10 included in the error announcement screen against the identification information on the label 16a (see FIG. 4B) attached to each load sensor 10 in use, the user can identify the load sensor 10 in which the error has occurred from among the load sensors 10 in use. Thus, the user can smoothly advance the subsequent measure such as replacing the load sensor 10 in which the error has occurred with a new load sensor 10.

### Effects of Embodiment 1

According to the present embodiment, the following effects are exhibited.

As shown in FIG. 1A to FIG. 4B, FIG. 5, and FIGS. 6A, 6B, the load sensor 10 includes: at least one electrically-conductive member 13a (first electrode); at least one electrically-conductive elastic body 12 (second electrode) disposed so as to cross the electrically-conductive member 13a (first electrode); the dielectric body 13b present between the electrically-conductive member 13a (first electrode) and the electrically-conductive elastic body 12 (second electrode); the resistor array 111 that has a plurality of resistors 111a in series connection and in which both ends of the series connection are respectively connected to the power supply line L10 on the detection circuit 20 side and the ground line L13; and the wiring pattern (connection part) on the circuit board 16 and the switch element 112 (connection part) that connect, to the electrically-conductive member 13a (first electrode), one point (connection terminal 111b) out of both ends of the resistor array 111 and the connection position between the resistors 111a adjacent to each other. Here, the above point of the resistor array 111 to which the switch element 112 is connected is set to a position corresponding to the identification information of the load sensor 10.

With this configuration, as described with reference to FIG. 8, when the power supply voltage Vcc has been applied to the resistor array 111 via the power supply line L10, a voltage according to the position of the point, i.e., the identification information, appears in the electrically-conductive member 13a (first electrode). Therefore, by detecting, on the detection circuit 20 side, the voltage that appears in the electrically-conductive member 13a (first electrode) when the power supply voltage Vcc has been applied to the resistor array 111, the identification information of the load sensor 10 can be acquired. Therefore, identification of the load sensor 10 can be performed in a simple manner.

As shown in FIG. 5, the switch element 112 that switches the connection position (point) of the resistor array 111 and the conductor wire 13 (the electrically-conductive member 13a: first electrode), between connection and non-connection is disposed. Therefore, as shown in FIG. 9, by opening the switch element 112 when the capacitance in an element part is to be measured, the resistor array 111 can be disconnected from the conductor wire 13 (the electrically-conductive member 13a: first electrode). Therefore, in measurement of the capacitance in the element part, occurrence of influence of the resistor array 111 on the voltage that is outputted from the output terminal 217 can be appropriately prevented.

As shown in FIG. 5, the detection circuit 20 includes the switch 221 that switches the power supply line L10 and the wiring cable L14 connected to both of the resistor array 111 and the switch element 112, between connection and non-connection. When the switch 221 has been closed, and accordingly, the power supply line L10 has been connected to the wiring cable L14 and the power supply voltage Vcc has been applied, the switch element 112 operates so as to connect the connection position (point) of the resistor array 111 and the conductor wire 13 (the electrically-conductive member 13a: first electrode) to each other. With this configuration, without providing a configuration for switching the switch element 112 on the load sensor 10 side, the switch element 112 can be set to a conductive state merely by applying the power supply voltage Vcc from the detection circuit 20 side to the switch element 112. Therefore, the configuration of the load sensor 10 can be simplified.

As shown in FIG. 1A to FIG. 4B and FIG. 5, the load sensor 10 includes a plurality of the electrically-conductive members 13a (first electrodes), and includes a set of the resistor array 111 and the switch element 112 (connection part) for each of the electrically-conductive members 13a (first electrode). Thus, since a plurality of sets of the resistor array 111 and the switch element 112 are included, the number of digits (combinations of numbers) of the identification information can be increased. Therefore, the kinds of the identification information that can be set can be increased.

As shown in FIG. 1A to FIG. 4B, the load sensor 10 includes a plurality of the electrically-conductive elastic bodies 12 (second electrodes), and crossing positions between a plurality of the first electrodes and a plurality of the second electrodes are disposed in a matrix shape. With this configuration, the number of the crossing positions (element parts) can be increased, and the distribution of the load can be measured in a wider area.

As shown in FIG. 4B, a representation (the label 16a) indicating the identification information is attached to a surface of the load sensor 10. Therefore, by referring to this representation (the label 16a), the user can smoothly and accurately grasp where the load sensor 10 corresponding to the identification information read from the resistor array 111 is. Thus, for example, when an error has occurred, the user can smoothly identify the load sensor 10 in which the error has occurred, and can smoothly carry out replacement work, etc. of the load sensor 10.

As shown in FIG. 4B, the storage medium 16b from which the identification information is readable is attached to a surface of the load sensor 10. Therefore, as described above, by reading the identification information from the storage medium 16b with a portable terminal, a bar code reader, or the like, the user can manage the identification information of each load sensor 10. For example, the user can manage the arrangement layout of the load sensors 10, and can smoothly confirm erroneous arrangement, missing arrangement, or the like of each load sensor 10.

As described with reference to FIG. 9, in the capacitance measurement mode, the detection circuit 20 applies the power supply voltage Vcc to the electrically-conductive member 13a (first electrode) and outputs, to the output terminal 217, a voltage of the electrically-conductive member 13a (first electrode) that changes in accordance with the capacitance at the crossing position between the electrically-conductive member 13a (first electrode) and the electrically-conductive elastic body 12 (second electrode). As described with reference to FIG. 8, in the identification information reading mode, the detection circuit 20 applies the power supply voltage Vcc to the resistor array 111 and outputs the voltage appearing at the connection position (point) of the switch element 112 with respect to the resistor array 111, to the output terminal 217 via the electrically-conductive member 13a (first electrode). Therefore, the output terminal 217 can be used in common for measurement of the capacitance and reading of the identification information. Therefore, the detection circuit 20 can be simplified.

As shown in FIG. 10, the load detecting device 1 includes the control circuit 30 that detects, in the capacitance measurement mode, capacitance at the crossing position between the electrically-conductive member 13a (first electrode) and the electrically-conductive elastic body 12 (second electrode) from the voltage outputted from the output terminal 217, and that acquires, in the identification information reading mode, the identification information of the load sensor 10 from the voltage outputted from the output terminal 217. Accordingly, from the voltages outputted from the common output terminal 217, the load at the crossing position (element part) and the identification information of the load sensor 10 can be respectively acquired.

### Embodiment 2

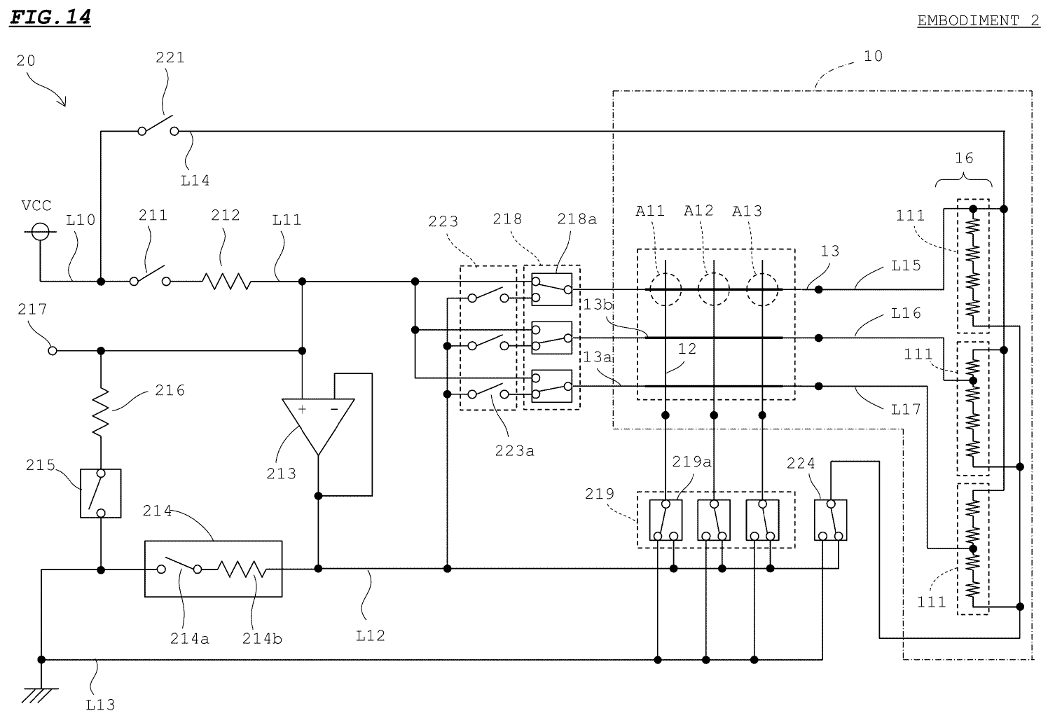

FIG. 14 is a circuit diagram showing configurations of the detection circuit 20 and the load sensor 10 according to Embodiment 2.

Similar to FIG. 5, in FIG. 14, for convenience, as the configuration of the load detection region of the load sensor 10, only the conductor wires 13 and the electrically-conductive elastic bodies 12 are shown, and each electrically-conductive elastic body 12 is shown in a linear shape.

As compared with FIG. 5, in FIG. 14, the switch elements 112 and the resistor 222 are omitted. The three resistor arrays 111 are directly connected to the three conductor wires 13 (the electrically-conductive members 13a) by wiring cables L15, L16, L17. This connection is performed on the circuit board 16. On the detection circuit 20 side, a third switchover part 223 and a multiplexer 224 are added. The other configuration is the same as the configuration in FIG. 5.

In the configuration in FIG. 14 as well, as in the case of FIG. 5, depending on which of the five connection terminals 111b in FIG. 7A the wiring cable L15, L16, L17 is connected to, the identification information (e.g., manufacturing serial number) of the load sensor 10 is retained in the resistor array 111.

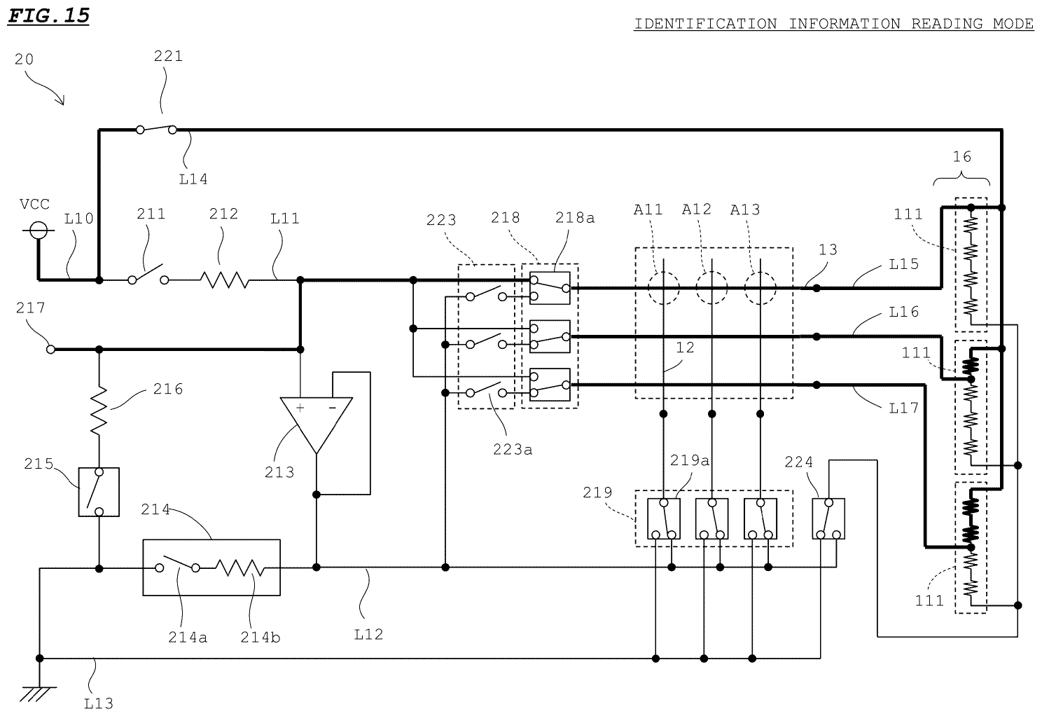

FIG. 15 shows a state of the detection circuit 20 during reading of identification information (identification information reading mode). In FIG. 15, for convenience, wiring cables and resistors related to identification information reading are indicated by thick lines.

During identification information reading, the switches 211, 214, 215 are opened. The multiplexer 224 is connected to the ground line L13 side. In this state, by the switch 221 being closed, the power supply voltage Vcc is supplied to each of the three resistor arrays 111. Accordingly, a voltage according to the connection form of each of the wiring cables L15 to L17 to a corresponding resistor array 111, i.e., which of the five connection terminals 111b in FIG. 6A the wiring cable L15 to L17 is connected, is applied to a corresponding conductor wire 13 (the electrically-conductive member 13a).

Here, in the state in FIG. 15, among the three multiplexers 218a of the first switchover part 218, only the multiplexer 218a in the uppermost row is connected to the supply line L11. Therefore, the voltage applied to the conductor wire 13 in the uppermost row from the resistor array 111 in the uppermost row is supplied to the output terminal 217 via the supply line L11.

At this time, to the three electrically-conductive elastic bodies 12 crossing the conductor wire 13 in the uppermost row, the suppression voltage having the same potential as that in the supply line L11 is being applied from the equipotential generator 213, and thus, the element parts A11 to A13 are disabled in terms of circuitry. Therefore, the voltage from the resistor array 111 in the uppermost row is appropriately reflected in the output terminal 217. Therefore, by the above-described control circuit 30 detecting the voltage at the output terminal 217, the numeral assigned according to the connection form between the resistor array 111 in the uppermost row and the wiring cable L15 is acquired.

From the state in FIG. 15, the first switchover part 218 is set such that only the conductor wire 13 in the middle row is connected to the supply line L11, whereby the voltage applied from the resistor array 111 in the middle row to the conductor wire 13 is supplied to the output terminal 217 via the supply line L11. By the control circuit 30 detecting the voltage at the output terminal 217 at this time, the numeral assigned according to the connection form between the resistor array 111 in the middle row and the wiring cable L16 is acquired.

From the state in FIG. 15, the first switchover part 218 is set such that only the conductor wire 13 in the lowermost row is connected to the supply line L11, whereby the voltage applied from the resistor array 111 in the lowermost row to the conductor wire 13 is supplied to the output terminal 217 via the supply line L11. By the control circuit 30 detecting the voltage at the output terminal 217 at this time, the numeral assigned according to the connection form between the resistor array 111 in the lowermost row and the wiring cable L17 is acquired.

From the three numerals acquired in this manner, three-digit identification information associated with the load sensor 10 is acquired. Then, the identification information acquisition operation ends.

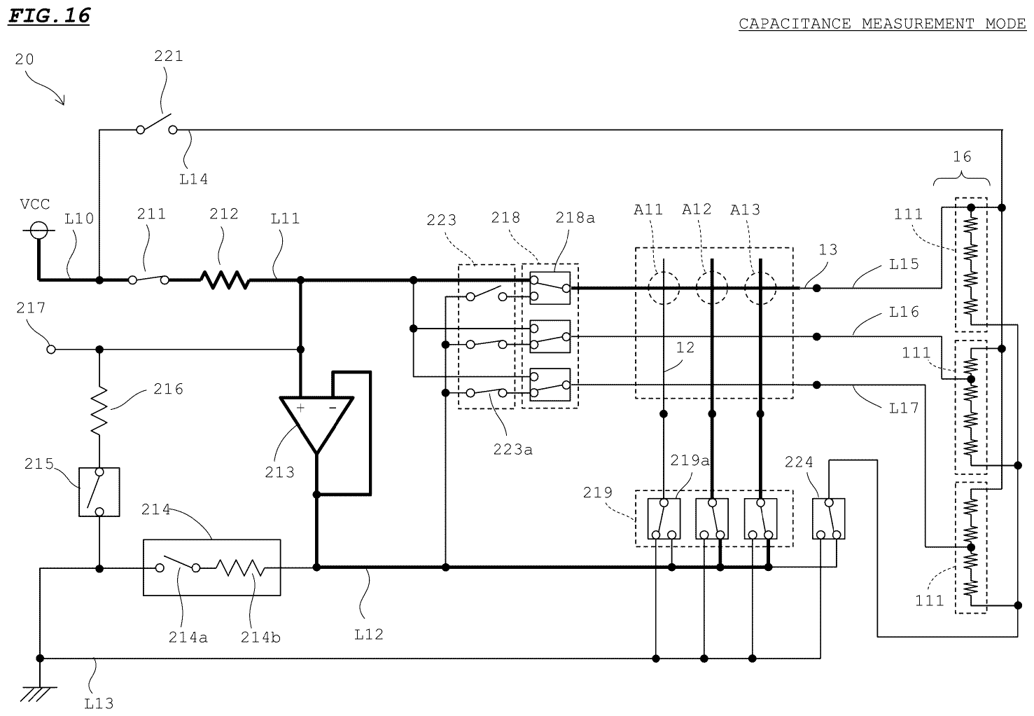

FIG. 16 shows a state of the detection circuit 20 during capacitance measurement (capacitance measurement mode). Here, the element part A11 is the measurement target. In FIG. 16, for convenience, wiring cables and resistors related to capacitance measurement are indicated by thick lines.

As shown in FIG. 16, the three multiplexers 218a included in the first switchover part 218 and the three multiplexers 219a included in the second switchover part 219 are set to the state in FIG. 5. That is, the multiplexer 218a in the uppermost row connected to the conductor wire 13 (the electrically-conductive member 13a) forming one electrode of the element part A11 is connected to the supply line L11, and the multiplexer 219a in the leftmost row connected to the electrically-conductive elastic body 12 forming the other electrode of the element part A11 is connected to the ground line L13. The switches 211, 221, 214, 215 are set to an open state as in FIG. 5.

As for the third switchover part 223, only a switch 223a in the uppermost row is opened and the remaining two switches 223a are closed. The multiplexer 224 is connected to the supply line L12.

In this state, the switch 211 is closed for a certain period. Accordingly, the power supply voltage Vcc is applied to the element part A11, and in accordance with accumulation of electricity in the element part A11, the voltage at the output terminal 217 increases according to the time constant defined by the capacitance in the element part A11 and the resistor 212. As described above, the capacitance in the element part A11 has a value according to the load being applied to the element part A11. Therefore, the voltage value at the output terminal 217 after elapse of a predetermined period after the switch 211 has been closed becomes a value according to the load being applied to the element part A11. From this voltage value, the above-described control circuit 30 calculates the load according to the capacitance in the element part A11.

In the state in FIG. 16, since the multiplexer 224 is connected to the supply line L12, the same potential as that in the supply line L11 is applied to both ends of the resistor array 111 in the uppermost row. Therefore, the resistor array 111 in the uppermost row is disabled. Since the switches 223a in the middle row and the lowermost row of the third switchover part 223 are closed, the same potential as that in the supply line L11 is applied to both ends and the connection positions of the resistor arrays 111 in the middle row and the lowermost row. Therefore, the resistor arrays 111 in the middle row and the lowermost row are also disabled.

Thus, since all of the three resistor arrays 111 are disabled, these three resistor arrays 111 do not influence the voltage at the output terminal 217. Therefore, from the voltage at the output terminal 217, the capacitance and the load in the element part A11 can be appropriately calculated.

When the capacitance measurement with respect to the element part A11 has ended, the switch 211 is opened, the switches 214, 215 are closed, and discharging is performed, as in Embodiment 1 above. Then, with respect to the other element parts as well, with the first switchover part 218, the second switchover part 219, and the third switchover part 223 similarly controlled, the power supply voltage Vcc is applied to the detection target element part, and from the voltage value at the output terminal 217, the load in the detection target element part is calculated. Then, when load detection has been performed with respect to all the element parts, the same control is performed from the element part A11 and load detection in each element part in the next routine is performed again.

The processes in FIG. 12 and FIG. 13 can be performed in the same manner also in the configuration in Embodiment 2.

### Effects of Embodiment 2

In Embodiment 2 as well, effects similar to those in Embodiment 1 can be exhibited.

In the configuration in Embodiment 2, since the connection terminal 111b (point) of the resistor array 111 and the conductor wire 13 (the electrically-conductive member 13a: first electrode) are directly connected to each other by the wiring cables L15 to L17, the switch element 112 can be omitted as compared with the configuration in Embodiment 1. Therefore, the configuration of the load sensor 10 can be more simplified.

### Modification

In the embodiments above, the detection circuit 20 is connected to the load sensor 10 such that the electrically-conductive member 13a serves as the positive electrode of the element part and the electrically-conductive elastic body 12 serves as the negative electrode of the element part. However, the detection circuit 20 may be connected to the load sensor 10 such that the electrically-conductive member 13a serves as the negative electrode of the element part and the electrically-conductive elastic body 12 serves as the positive electrode of the element part. In this case, the electrically-conductive elastic body 12 corresponds to “first electrode” described in the claims, and the electrically-conductive member 13a corresponds to “second electrode” described in the claims.

In the embodiments above, as shown in FIG. 4B, both of the label 16a and the storage medium 16b are disposed on the surface of the load sensor 10, but either one of them may be omitted. However, in order to allow the user to easily grasp the identification information of each load sensor 10 visually and to smoothly compare the grasped identification information with the identification information acquired from the resistor array 111, it is preferable that at least the representation of the identification information by means of the label 16a or the like is provided.

The method of providing the representation indicating the identification information on the surface of the load sensor 10 is not limited to the method of attaching the label 16a to the surface of the load sensor 10 as in Embodiments 1, 2 above. For example, the identification information may be directly printed on the surface of the load sensor 10, or the identification information may be written by hand on the surface of the load sensor 10.

The method of measuring the capacitance in each element part is not limited to the method described in Embodiments 1, 2 above. For example, the voltage outputted from the output terminal 217 in the period from when a voltage has been applied to the element part until this voltage becomes stable may be accumulated, to calculate the electric charge amount accumulated in the element part, and from the calculated electric charge amount, the capacitance in the element part may be calculated.

The element parts need not necessarily be disposed in a matrix shape. For example, a configuration in which a plurality of conductor wires 13 and one electrically-conductive elastic body 12 are caused to cross each other, whereby element parts are arranged only in one column, may be adopted. In addition, the number of element parts need not necessarily be plural, and may be one. In this case, if the number of resistors in the resistor array 111 is increased, the kinds of identification information can be increased.

In addition, the resistor arrays 111 need not necessarily be disposed in association with all of the conductor wires 13 (the electrically-conductive members 13a). For example, when a large number of conductor wires 13 (the electrically-conductive members 13a) are disposed, the resistor arrays 111 may be associated with conductor wires 13 (the electrically-conductive members 13a) in the number necessary for realizing the required number of kinds of identification information.

In Embodiments 1, 2 above, one conductor wire 13 is assigned to one element part. However, a plurality of conductor wires 13 may be assigned to one element part. For example, in the configuration in FIG. 4A, with respect to the region of the element parts A11 to A13, two conductor wires 13 may be disposed so as to be arranged in the Y-axis direction. In each of the region of the element parts A21 to A23 and the region of the element parts A31 to A33 as well, two conductor wires 13 may be disposed so as to be arranged in the Y-axis direction. In this case, the two conductor wires 13 disposed in each of the region of the element parts A11 to A13, the region of the element parts A21 to A23, and the region of the element parts A31 to A33 have end portions on the X-axis positive side connected to each other, or connected to each other in the circuit board 16 or in the detection circuit 20. When a plurality of conductor wires 13 are assigned to one element part like this, change in the contact area between the dielectric body 13b and the electrically-conductive elastic body 12 with respect to a load becomes large, and thus, load detection sensitivity can be enhanced.

When a plurality of conductor wires 13 are assigned to one element part like this, the total number of the conductor wires 13 that are disposed increases, and thus, the number of the resistor arrays 111 that can be disposed also increases. Therefore, the digit number of the identification information of the load sensor 10 can be increased, and the kinds of the identification information can be increased. In this case, the detection circuit 20 may be configured so as to: during capacitance measurement, connect a plurality of conductor wires 13 assigned to one element part to each other and connect the resultant conductor wire 13 to the output terminal 217; and during identification information reading, individually connect the plurality of conductor wires 13 assigned to one element part, to the output terminal 217. Accordingly, measurement of capacitance in each element part and reading of identification information at each resistor array 111 can be smoothly performed.

The configuration of the detection circuit 20 is not limited to the configuration shown in FIG. 5 or FIG. 14. As long as the capacitance in the element part can be measured and the identification information retained in the resistor array 111 can be acquired, the configuration of the detection circuit 20 can be changed as appropriate.

In Embodiments 1, 2 above, the first switchover part 218 and the second switchover part 219 are implemented by the multiplexers 218a, 219a. However, the first switchover part 218 and the second switchover part 219 may be implemented by a switching circuit other than a multiplexer.

The control performed by the control circuit 30 is not limited to the control in FIGS. 12, 13 shown in Embodiment 1 above, and can be changed as appropriate.

The voltage applied to the power supply connection terminal 111c of the resistor array 111 and the voltage applied to the conductor wire 13 via the supply line L11 may be different from each other.

In the embodiments above, the conductor wire 13 is implemented by a covered copper wire, but not limited thereto, may be composed of a linear-shaped electrically-conductive member formed from a substance other than copper and a dielectric body covering the electrically-conductive member. The electrically-conductive member may be implemented by a twisted wire. In the embodiments above, the conductor wire 13 extends in a straight-line shape, but the conductor wire 13 may meander in the Y-axis direction.

In the embodiments above, the electrically-conductive elastic bodies 12 are provided only on the face on the Z-axis positive side of the base member 11. However, electrically-conductive elastic bodies may be provided also on the face on the Z-axis negative side of the base member 15. In this case, the electrically-conductive elastic bodies on the base member 15 side are configured similarly to the electrically-conductive elastic bodies 12 on the base member 11 side, and are disposed so as to overlap the electrically-conductive elastic bodies 12 so as to sandwich the conductor wires 13 therebetween in a plan view. Then, the wiring cables drawn from the electrically-conductive elastic bodies on the base member 15 side are connected to the wiring cables W1 drawn from the electrically-conductive elastic bodies 12 opposed in the Z-axis direction. When the electrically-conductive elastic bodies are provided above and below the conductor wires 13 in this manner, change in the capacitance in each element part becomes approximately twice correspondingly to the upper and lower electrically-conductive elastic bodies. Therefore, the detection sensitivity of the load applied to the element part can be enhanced.

In the embodiments above, the dielectric body 13b is formed on the electrically-conductive member 13a so as to cover the outer periphery of the electrically-conductive member 13a. However, instead of this, the dielectric body 13b may be formed on the upper face of the electrically-conductive elastic body 12. In this case, in accordance with application of a load, the electrically-conductive member 13a sinks in and is wrapped by the dielectric body 13b and the electrically-conductive elastic body 12, and the contact area between the electrically-conductive member 13a and the electrically-conductive elastic body 12 changes. Accordingly, similar to the embodiments above, the load applied to each element part can be detected.

In the embodiments above, each element part is formed by the electrically-conductive elastic body 12 and the conductor wire 13 crossing each other. However, the configuration of the element part is not limited thereto. For example, the element part may be formed by a hemisphere-shaped electrically-conductive elastic body and a flat-plate-shaped electrode sandwiching a dielectric body. In this case, the dielectric body may be formed on the surface of the electrode opposing the electrically-conductive elastic body, or may be formed on the surface of the hemisphere-shaped electrically-conductive elastic body.

In addition to the above, various modifications can be made as appropriate to the embodiments of the present invention without departing from the scope of the technical idea defined by the claims.

### Additional Note

The following technologies are disclosed by the description of the embodiments above.

### Technology 1

A load sensor comprising:
at least one first electrode;
at least one second electrode disposed so as to cross the first electrode;
a dielectric body present between the first electrode and the second electrode;
a resistor array that has a plurality of resistors in series connection and in which both ends of the series connection are respectively connected to a power supply line on a side of a detection circuit and a ground line; and
a connection part configured to connect, to the first electrode, one point out of the both ends of the resistor array and a connection position between the resistors adjacent to each other of the resistor array, wherein
the point is set to a position corresponding to identification information of the load sensor.

According to this technology, when the power supply voltage has been applied to the resistor array via the power supply line, a voltage according to the position of the point, i.e., the identification information, appears in the first electrode. Therefore, by detecting, on the detection circuit side, the voltage that appears in the first electrode when the power supply voltage has been applied to the resistor array, the identification information of the load sensor can be acquired. Therefore, identification of the load sensor can be performed in a simple manner.

### Technology 2

The load sensor according to technology 1, wherein
the connection part comprises a switch element configured to switch the point and the first electrode, between connection and non-connection.

According to this technology, by opening the switch element when the capacitance in an element part is to be measured, the resistor array can be disconnected from the first electrode. Therefore, in measurement of the capacitance in the element part, occurrence of influence of the resistor array on the voltage that is outputted from the output terminal can be appropriately prevented.

### Technology 3

The load sensor according to technology 2, wherein
the detection circuit comprises a configuration configured to switch the power supply line and a wiring cable connected to both of the resistor array and the switch element, between connection and non-connection, and
when the power supply line has been connected to the wiring cable and a power supply voltage has been applied, the switch element operates so as to connect the point and the first electrode to each other.

According to this technology, without providing a configuration for switching the switch element on the load sensor side, the switch element can be set to a conductive state by merely applying the power supply voltage from the detection circuit side to the switch element. Therefore, the configuration of the load sensor can be simplified.

### Technology 4

The load sensor according to technology 1, wherein
the connection part is a wiring cable that directly connects the point and the first electrode to each other.

According to this technology, the switch element can be omitted. Therefore, the configuration of the load sensor can be more simplified.

### Technology 5

The load sensor according to any one of technologies 1 to 4,
comprising a plurality of the first electrodes, and
comprising a set of the resistor array and the connection part for each of the first electrodes.

According to this technology, since a plurality of sets of the resistor array and the switch element can be disposed, the combinations of numbers of pieces of the identification information can be increased. Therefore, the kinds of the identification information that can be set can be increased.

### Technology 6

The load sensor according to technology 5, comprising
a plurality of the second electrodes, wherein
crossing positions between a plurality of the first electrodes and a plurality of the second electrodes are disposed in a matrix shape.

According to this technology, the number of the crossing positions can be increased, and the distribution of the load can be measured in a wider area.

### Technology 7

The load sensor according to any one of technologies 1 to 6, wherein
a representation indicating the identification information is attached to a surface of the load sensor.

According to this technology, by referring to this representation, the user can smoothly and accurately grasp where the load sensor corresponding to the identification information read from the resistor array is. Thus, for example, when an error has occurred, the user can smoothly identify the load sensor in which the error has occurred, and can smoothly carry out replacement work, etc. of the load sensor.

### Technology 8

The load sensor according to any one of technologies 1 to 7, wherein
a storage medium from which the identification information is readable is attached to a surface of the load sensor.

According to this technology, by reading the identification information from the storage medium with a reading device, the user can manage the identification information of each load sensor. For example, the user can manage the arrangement layout of the load sensors, and can smoothly confirm erroneous arrangement, missing arrangement, or the like of each load sensor.

### Technology 9

A load detecting device comprising:
the load sensor according to any one of technologies 1 to 8; and
the detection circuit.

According to this technology, since the load sensor according to any one of technologies 1 to 8 is included, effects similar to those in technologies 1 to 8 can be exhibited.

### Technology 10

The load detecting device according to technology 9, wherein
the detection circuit
   in a capacitance measurement mode, applies a power supply voltage to the first electrode and outputs, to an output terminal, a voltage of the first electrode that changes in accordance with capacitance at a crossing position between the first electrode and the second electrode, and
   in an identification information reading mode, applies a power supply voltage to the resistor array and outputs a voltage appearing at the point, to the output terminal via the first electrode.

According to this technology, the output terminal can be used in common for measurement of the capacitance and reading of the identification information. Therefore, the detection circuit can be simplified.

### Technology 11

The load detecting device according to technology 10, comprising
a control circuit configured to
   detect, in the capacitance measurement mode, capacitance at the crossing position from a voltage outputted from the output terminal, and
   acquire, in the identification information reading mode, the identification information from a voltage outputted from the output terminal.

According to this technology, from the voltages outputted from the common output terminal, the load at the crossing position and the identification information of the load sensor can be respectively acquired.

What is claimed is:

1. A load sensor comprising:
at least one first electrode;
at least one second electrode disposed so as to cross the first electrode;
a dielectric body present between the first electrode and the second electrode;
a resistor array that has a plurality of resistors in series connection and in which both ends of the series connection are respectively connected to a power supply line on a side of a detection circuit and a ground line; and
a connection part configured to connect, to the first electrode, one point out of the both ends of the resistor array and a connection position between the resistors adjacent to each other of the resistor array, wherein
the point is set to a position corresponding to identification information of the load sensor.

2. The load sensor according to claim 1, wherein
the connection part comprises a switch element configured to switch the point and the first electrode, between connection and non-connection.

3. The load sensor according to claim 2, wherein
the detection circuit comprises a configuration configured to switch the power supply line and a wiring cable connected to both of the resistor array and the switch element, between connection and non-connection, and
when the power supply line has been connected to the wiring cable and a power supply voltage has been applied, the switch element operates so as to connect the point and the first electrode to each other.

4. The load sensor according to claim 1, wherein
the connection part is a wiring cable that directly connects the point and the first electrode to each other.

5. The load sensor according to claim 1,
comprising a plurality of the first electrodes, and
comprising a set of the resistor array and the connection part for each of the first electrodes.

6. The load sensor according to claim 5, comprising
a plurality of the second electrodes, wherein
crossing positions between a plurality of the first electrodes and a plurality of the second electrodes are disposed in a matrix shape.

7. The load sensor according to claim 1, wherein
a representation indicating the identification information is attached to a surface of the load sensor.

8. The load sensor according to claim 1, wherein
a storage medium from which the identification information is readable is attached to a surface of the load sensor.

9. A load detecting device comprising;
a load sensor; and
a detection circuit, wherein
the load sensor includes
at least one first electrode,
at least one second electrode disposed so as to cross the first electrode,
a dielectric body present between the first electrode and the second electrode,
a resistor array that has a plurality of resistors in series connection and in which both ends of the series connection are respectively connected to a power supply line on a side of the detection circuit and a ground line, and
a connection part configured to connect, to the first electrode, one point out of the both ends of the resistor array and a connection position between the resistors adjacent to each other of the resistor array, and
the point is set to a position corresponding to identification information of the load sensor.

10. The load detecting device according to claim 9, wherein
the detection circuit
in a capacitance measurement mode, applies a power supply voltage to the first electrode and outputs, to an output terminal, a voltage of the first electrode that changes in accordance with capacitance at a crossing position between the first electrode and the second electrode, and
in an identification information reading mode, applies a power supply voltage to the resistor array and outputs a voltage appearing at the point, to the output terminal via the first electrode.

11. The load detecting device according to claim 10, comprising
a control circuit configured to
detect, in the capacitance measurement mode, capacitance at the crossing position from a voltage outputted from the output terminal, and
acquire, in the identification information reading mode, the identification information from a voltage outputted from the output terminal.

12. The load detecting device according to claim 9, wherein
the connection part comprises a switch element configured to switch the point and the first electrode, between connection and non-connection.

13. The load detecting device according to claim 12, wherein
the detection circuit comprises a configuration configured to switch the power supply line and a wiring cable connected to both of the resistor array and the switch element, between connection and non-connection, and
when the power supply line has been connected to the wiring cable and a power supply voltage has been applied, the switch element operates so as to connect the point and the first electrode to each other.

14. The load detecting device according to claim 9, wherein
the connection part is a wiring cable that directly connects the point and the first electrode to each other.

15. The load detecting device according to claim 9,
comprising a plurality of the first electrodes, and
comprising a set of the resistor array and the connection part for each of the first electrodes.

16. The load detecting device according to claim 15, comprising
a plurality of the second electrodes, wherein
crossing positions between a plurality of the first electrodes and a plurality of the second electrodes are disposed in a matrix shape.

17. The load detecting device according to claim 9, wherein
a representation indicating the identification information is attached to a surface of the load sensor.

18. The load detecting device according to claim 9, wherein
a storage medium from which the identification information is readable is attached to a surface of the load sensor.
